(19) United States
(12) Patent Application Publication
(10) Pub. No.: US 2026/0321980 A1
(43) Pub. Date: Oct. 15, 2026

(54) ANTENNA DEVICE

(71) Applicant: Mitsubishi Electric Corporation, Tokyo (JP)

(72) Inventors: Hirofumi OGURA, Tokyo (JP); Hiroaki SAKAMOTO, Tokyo (JP); Kengo NISHIMOTO, Tokyo (JP)

(73) Assignee: Mitsubishi Electric Corporation, Tokyo (JP)

(21) Appl. No.: 19/646,117

(22) Filed: Apr. 13, 2026

Related U.S. Application Data
(63) Continuation of application No. PCT/JP2024/000093, filed on Jan. 9, 2024.

(51) Int. Cl. H01Q 9/04

(52) U.S. Cl. CPC H01Q 9/045

(57) ABSTRACT

An antenna device includes: a flat ground conductor plate; a first antenna element having a first linear conductor extending perpendicularly to the ground conductor plate, and a second linear conductor with a spiral shape that is continuous with the first linear conductor and extends parallel to the ground conductor plate; and a second antenna element having a third linear conductor extending perpendicularly to the ground conductor plate, and a fourth linear conductor with a spiral shape that is continuous with the third linear conductor and extends parallel to the ground conductor plate, in which the first antenna element and the second antenna element are arranged in mirror symmetry with respect to a virtual plane perpendicular to the ground conductor plate, and an electrical length of a shortest distance between the first antenna element and the second antenna element is equal to or shorter than 1/10 of an operating wavelength.

### CROSS REFERENCE TO RELATED APPLICATION

This application is a Continuation of PCT International Application No. PCT/JP2024/000093, filed on Jan.9, 2024, which is hereby expressly incorporated by reference into the present application.

### TECHNICAL FIELD

The present disclosure relates to an antenna device.

### BACKGROUND ART

In recent years, along with the development of fields such as wireless communication systems, positioning, radar, and sensing, the demand for high-gain antenna technologies has been increasing. In addition, devices have been miniaturized in each field, and the demand for the miniaturization of antennas has also been increasing. There is Non-Patent Literature 1 as a document teaching an antenna to satisfy these demands. Non-Patent Literature 1 discloses an antenna in which four spiral antenna elements to be fed from a single feed point are arranged on a plane parallel to a ground conductor plate (FIG. 1 of Non-Patent Literature 1).

### CITATION LIST

### Non-Patent Literature

Non-Patent Literature 1: K. Hirose, M. Nakatsu, and H. Nakano, “Dual-curl antennas for broadband circular polarization,” ELECTRONICS LETTERS, July 2021, Vol. 57, No. 14

### SUMMARY OF INVENTION

### Technical Problem

However, according to the antenna configuration taught in Non-Patent Literature 1, a phase shift occurs in the current flowing through the proximity portion between adjacent antenna elements. Accordingly, there is a problem that further reducing the distance between the antenna elements results in a decrease of the gain of the antenna.

The present disclosure has been made to solve such a problem, and an object thereof is to provide an antenna device that can be miniaturized as compared to conventional technologies while satisfying the demand for higher gain.

### Solution to Problem

An aspect of antenna device according to an embodiment of the present disclosure includes: a flat ground conductor plate; a first antenna element having a first linear conductor extending perpendicularly to the ground conductor plate, and a second linear conductor with a spiral shape that is continuous with the first linear conductor and extends parallel to the ground conductor plate; a first feed point to supply power to the first antenna element, the first feed point being grounded to the ground conductor plate; a second antenna element having a third linear conductor extending perpendicularly to the ground conductor plate, and a fourth linear conductor with a spiral shape that is continuous with the third linear conductor and extends parallel to the ground conductor plate; and a second feed point to supply power to the second antenna element, the second feed point being grounded to the ground conductor plate, in which the first antenna element and the second antenna element are arranged in mirror symmetry with respect to a virtual plane perpendicular to the ground conductor plate, the first feed point and the second feed point are arranged in mirror symmetry with respect to the virtual plane, and an electrical length of a shortest distance between the first antenna element and the second antenna element is equal to or shorter than 1/10 of an operating wavelength, in which the second linear conductor and the fourth linear conductor each have a plurality of bend sections bent at right angles along a same direction multiple times on a plane parallel to the ground conductor plate, and in which electrical lengths of all sections between adjacent bend sections of the second linear conductor are equal to or shorter than half the operating wavelength, and electrical lengths of all sections between adjacent bend sections of the fourth linear conductor are equal to or shorter than half the operating wavelength.

### Advantageous Effects of Invention

According to the antenna devices of the embodiments of the present disclosure, it is possible to achieve miniaturization as compared to conventional technologies while satisfying the demand for higher gain.

### BRIEF DESCRIPTION OF DRAWINGS

FIG. 1 is a drawing illustrating an example of the configuration of an antenna device according to a first embodiment.

FIG. 2 is a drawing illustrating the current distribution calculated by electromagnetic field simulation for checking the operation performed by the antenna device according to the first embodiment.

FIG. 3 is an enlarged view of FIG. 2 for checking the operation performed by the antenna device according to the first embodiment.

FIG. 4 is a drawing illustrating the active impedance calculated by electromagnetic field simulation for checking the operation performed by the antenna device according to the first embodiment.

FIGS. 5A to 5C are drawings illustrating the directional gain calculated by electromagnetic field simulation for checking advantageous effects of the antenna device according to the first embodiment. FIG. 5A is a drawing illustrating the directional gain on the ZX plane. FIG. 5B is a drawing illustrating the directional gain on the ZY plane. FIG. 5C is a drawing illustrating the directional gain on the XY plane.

FIG. 6 is a table illustrating the averaged values of the directional gain illustrated in FIGS. 5A to 5C for checking advantageous effects of the antenna device according to the first embodiment.

FIG. 7 is a drawing illustrating the frequency characteristics of the averaged gain on the horizontal plane (ZX plane) calculated by electromagnetic field simulation for checking advantageous effects of the antenna device according to the first embodiment.

FIG. 8 is a drawing illustrating an example of the configuration of an antenna device according to a second embodiment.

FIG. 9 illustrates the current distribution calculated by electromagnetic field simulation for checking the operation performed by the antenna device according to the second embodiment.

FIG. 10 is an enlarged view of FIG. 9 for checking the operation performed by the antenna device according to the second embodiment.

FIG. 11 is a drawing illustrating the active impedance calculated by electromagnetic field simulation for checking the operation performed by the antenna device according to the second embodiment.

FIGS. 12A to 12C are drawings illustrating the directional gain calculated by electromagnetic field simulation for checking advantageous effects of the antenna device according to the second embodiment. FIG. 12A is a drawing illustrating the directional gain on the ZX plane. FIG. 12B is a drawing illustrating the directional gain on the ZY plane. FIG. 12C is a drawing illustrating the directional gain on the XY plane.

FIG. 13 is a table illustrating the averaged values of the directional gain illustrated in FIGS. 12A to 12C for checking advantageous effects of the antenna device according to the second embodiment.

FIG. 14 is a drawing illustrating the frequency characteristics of the averaged gain on the horizontal plane (ZX plane) calculated by electromagnetic field simulation for checking advantageous effects of the antenna device according to the second embodiment.

### DESCRIPTION OF EMBODIMENTS

Hereinbelow, various embodiments in the present disclosure are explained in detail with reference to the drawings. Note that identical or similar portions are given identical or similar reference signs in the drawings, and overlapping explanation of such portions is omitted. In addition, in the present disclosure, unless otherwise specified, the term “or” is used in the meaning of an inclusive logical disjunction.

### First Embodiment

### Configuration

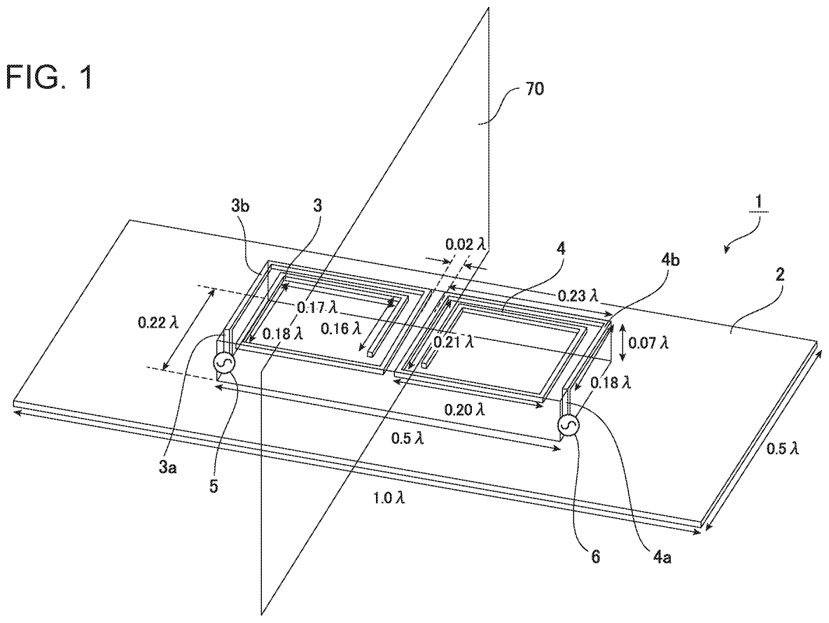

An antenna device 1 according to a first embodiment of the present disclosure is explained with reference to FIGS. 1 to 7. FIG. 1 is a drawing illustrating an example of the configuration of the antenna device 1 according to the first embodiment. In FIG. 1, λ represents the operating wavelength and is the free-space wavelength at a design frequency f0. As illustrated in FIG. 1, the antenna device 1 according to the first embodiment includes a ground conductor plate 2, an antenna element (first antenna element) 3, an antenna element (second antenna element) 4, a feed point (first feed point) 5, and a feed point (second feed point) 6. Note that a virtual plane 70 is drawn in FIG. 1 for the convenience of explanation. The ground conductor plate 2 has a flat shape. The virtual plane 70 is a plane perpendicular to the ground conductor plate 2. Both the antenna element 3 and the antenna element 4 have a helical shape. In the example illustrated in FIG. 1, both the antenna element 3 and the antenna element 4 have an angular spiral shape, and each of the antenna element 3 and the antenna element 4 has 7/4 turns in its spiral. The antenna element 3 and the antenna element 4 are arranged to be in mirror symmetry with respect to the virtual plane 70. In addition, the feed point 5 and the feed point 6 are also arranged to be in mirror symmetry with respect to the virtual plane 70.

The antenna element 3 includes: a linear conductor 3a (first linear conductor) extending perpendicularly to the ground conductor plate 2; and a linear conductor 3b (second linear conductor) that is continuous with the linear conductor 3a and extends parallel to the ground conductor plate 2. The linear conductor 3a and the linear conductor 3b may be a single linear conductor as a whole or may be formed integrally by connecting separate linear conductors. The linear conductor 3b is bent on a plane parallel to the ground conductor plate 2 in such a manner that the linear conductor 3b has a spiral shape.

Similarly to the antenna element 3, the antenna element 4 includes: a linear conductor 4a (third linear conductor) extending perpendicularly to the ground conductor plate 2; and a linear conductor 4b (fourth linear conductor) that is continuous with the linear conductor 4a and extends parallel to the ground conductor plate 2. The linear conductor 4a and the linear conductor 4b may be a single linear conductor as a whole or may be formed integrally by connecting separate linear conductors. The linear conductor 4b is bent on a plane parallel to the ground conductor plate 2 in such a manner that the linear conductor 4b has a spiral shape.

A first end of the linear conductor 3a is connected to the ground conductor plate 2 via the feed point 5. In addition, a first end of the linear conductor 4a is connected to the ground conductor plate 2 via the feed point 6.

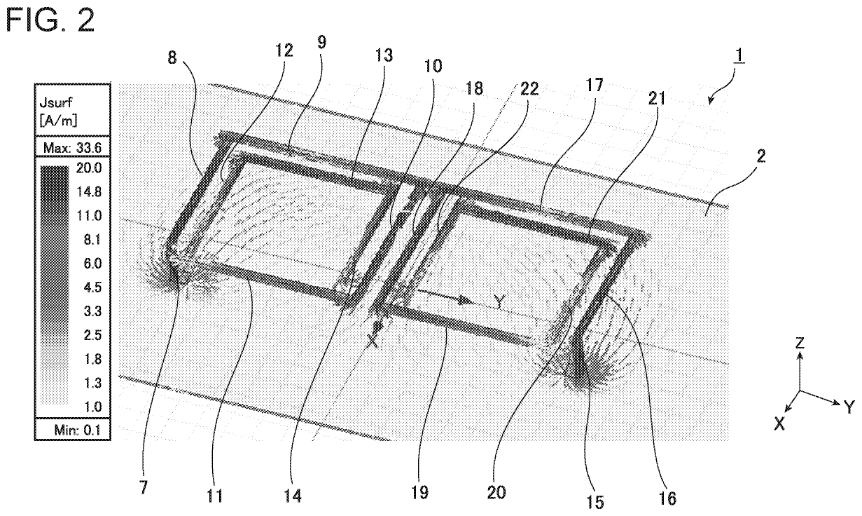

As illustrated in FIG. 2, the antenna element 3 includes the sections of a side 7 to a side 14. The side 7 is equivalent to the linear conductor 3a. The side 8 to the side 14 are equivalent to the linear conductor 3b as a whole.

In addition, as illustrated in FIG. 2, the antenna element 4 includes the sections of a side 15 to a side 22. The side 15 is equivalent to the linear conductor 4a. The side 16 to the side 22 are equivalent to the linear conductor 4b as a whole. Each of the side 7 to the side 22 has such a length that its electrical length is equal to or shorter than the half wavelength.

The side 7 of the antenna element 3 and the side 15 of the antenna element 4 have such lengths that their electrical lengths are equal to or shorter than 0.25 wavelengths. In a case where the electrical lengths of the side 7 and the side 15 are longer than 0.25 wavelengths, the directional gain on a plane parallel to the ground conductor plate 2 increases, and the directional gain on the horizontal plane (ZX plane) lowers undesirably; however, by making the electrical lengths of the side 7 and the side 15 equal to or shorter than 0.25 wavelengths, such a reduction in gain can be prevented.

As an example, the antenna element 3 and the antenna element 4 have a rectangular bent structure formed by bending the linear conductor 3b and the linear conductor 4b at right angles six times along the same direction on a plane parallel to the ground conductor plate 2. That is, the antenna element 3 and the antenna element 4 are formed by bending the linear conductor 3b and the linear conductor 4b at right angles six times along the same direction. As a result, the antenna element 3 has a rectangular shape with the side 8 to the side 14, and the antenna element 4 has a rectangular shape with the side 16 to the side 22.

Regarding the antenna element 3, the side 8 is a side extending parallel to the X axis. The side 9 is a side extending parallel to the Y axis. The side 10 is a side extending parallel to the X axis. The side 11 is a side extending parallel to the Y axis. The side 12 is a side extending parallel to the X axis. The side 13 is a side extending parallel to the Y axis. The side 14 is a side extending parallel to the X axis. The antenna element 3 is bent at right angles at the six points of connection, the point of connection between the side 8 and the side 9, the point of connection between the side 9 and the side 10, the point of connection between the side 10 and the side 11, the point of connection between the side 11 and the side 12, the point of connection between the side 12 and the side 13, and the point of connection between the side 13 and the side 14. The antenna element 3 has a plurality of bend sections (points of connection) at which the antenna element 3 is bent in this manner. The side 8 to the side 14 have such lengths that the approximate U-shape formed by the three sides, the side 12 to the side 14, is positioned on the inner side of the quadrilateral shape formed by the four sides, the side 8 to the side 11, on the XY plane. Note that, in the present disclosure, the term “approximate U-shape” includes cases where either or both of the angles at the ends of the base of the U-shape are 90 degrees. The electrical length of each side (section) of the side 8 to the side 14 is equal to or shorter than half the operating wavelength (half wavelength). In addition, the total of the electrical lengths of the side 7 to the side 14 is approximately an integer multiple of half the operating wavelength (half wavelength). Here, the term “approximately” means within the range of 10%, inclusive, from a reference value. For example, it is meant that, in a case where it is assumed that 1.5 wavelengths is the integer multiple of the half wavelength, the total is within the range of 1.35 to 1.65 wavelengths.

On the other hand, regarding the antenna element 4, the side 16 is a side extending parallel to the X axis. The side 17 is a side extending parallel to the Y axis. The side 18 is a side extending parallel to the X axis. The side 19 is a side extending parallel to the Y axis. The side 20 is a side extending parallel to the X axis. The side 21 is a side extending parallel to the Y axis. The side 22 is a side extending parallel to the X axis. The antenna element 4 is bent at right angles at the six points of connection, the point of connection between the side 16 and the side 17, the point of connection between the side 17 and the side 18, the point of connection between the side 18 and the side 19, the point of connection between the side 19 and the side 20, the point of connection between the side 20 and the side 21, and the point of connection between the side 21 and the side 22. The antenna element 4 has a plurality of bend sections (points of connection) at which the antenna element 4 is bent in this manner. The side 16 to the side 22 have such lengths that the approximate U-shape formed by the three sides, the side 20 to the side 22, is positioned on the inner side of the quadrilateral shape formed by the four sides, the side 16 to the side 19, on the XY plane. The electrical length of each side (section) of the side 16 to the side 22 is equal to or shorter than half the operating wavelength (half wavelength). In addition, the total of the electrical lengths of the side 15 to the side 22 is approximately an integer multiple of half the operating wavelength (half wavelength). Here, the term “approximately” means within the range of 10%, inclusive, from a reference value. For example, it is meant that, in a case where it is assumed that 1.5 wavelengths is the integer multiple of the half wavelength, the total is within the range of 1.35 to 1.65 wavelengths.

The antenna element 3 and the antenna element 4 having such structures are arranged to be in mirror symmetry with respect to the virtual plane 70. In the example illustrated in FIG. 1, the shortest distance between the antenna element 3 and the antenna element 4, that is, the distance between the side 10 of the antenna element 3 and the side 18 of the antenna element 4 is 0.02 wavelengths. The electrical length of the antenna element 3 and the electrical length of the antenna element 4, that is, the total electrical length of the side 7 to the side 14 and the total electrical length of the side 15 to the side 22, are approximately integer multiples of the half wavelength.

The feed point 5 and the feed point 6 are excited with equal amplitude and in phase. The feed point 5 is positioned at a corner of an antenna area which is a rectangular parallelepiped with minimum dimensions that accommodates the antenna element 3 and the antenna element 4. The expression “positioned at a corner” includes cases where the position is within the range of 0.03 wavelengths away from the corner. The feed point 6 is positioned in mirror symmetry with the feed point 5 with respect to the virtual plane 70 perpendicular to the ground conductor plate 2.

### Operation

Next, the operation performed by the antenna device 1 according to the first embodiment is explained with reference to FIGS. 2 to 4. FIG. 2 illustrates the current distribution calculated by electromagnetic field simulation when the feed point 5 and the feed point 6 of the antenna device 1 according to the first embodiment are excited with equal amplitude and in phase.

It can be seen from FIG. 2 that currents that flow through the side 8, the side 10, the side 12, the side 14, the side 16, the side 18, the side 20, and the side 22 extending in the X-axis direction are relatively large, and currents that flow through the side 9, the side 11, the side 13, the side 17, the side 19, and the side 21 extending in the Y-axis direction are relatively small. In particular, it can be seen that currents that flow through the side 8, the side 10, the side 16, and the side 18 are relatively large. In this manner, by making the electrical length of each side equal to or shorter than the half wavelength, currents that flow through sides extending in the X-axis direction can be increased, and, on the other hand, currents that flow through sides extending in the Y-axis direction can be reduced. Thereby, a plurality of directions along which large currents flow on the antenna device 1 are aligned with the X-axis direction, and the directional gain in the Z direction increases.

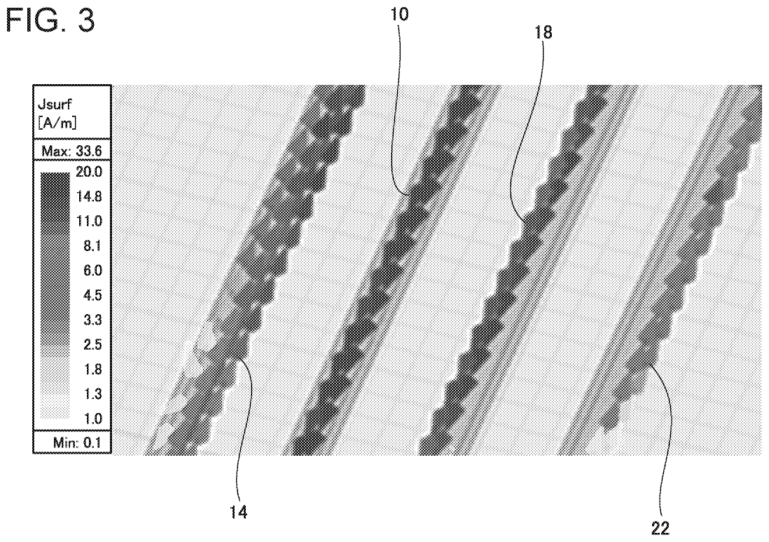

FIG. 3 is an enlarged view of the side 10, the side 14, the side 18, and the side 22 illustrated in FIG. 2. Among the four sides extending in the X-axis direction, currents that flow through the side 10 and the side 18 are large, and it can be seen that the currents flow through the side 10 and the side 18 in the same direction because the antenna element 3 and the antenna element 4 have shapes that are in mirror symmetry with respect to the virtual plane 70 perpendicular to the ground conductor plate 2, and the feed point 5 and the feed point 6 are excited with equal amplitude and in phase. Thereby, since the large currents flow through the side 10 and the side 18 and reinforce each other in phase, the overall current distribution across the side 10, the side 14, the side 18, and the side 22 can be regarded as equivalent to the sum of the currents that flow through the side 10 and the side 18.

As described above, the antenna device 1 according to the first embodiment exhibits a current distribution similar to that of a three-element array antenna since currents that flow through three locations, 1) the side 8, 2) the side 16, and 3) the position where the side 10 and the side 18 are viewed integrally, are in phase and large. Thereby, the directivity on the ZY plane can be narrowed, and the directional gain on the horizontal plane (ZX plane) can be enhanced.

Note that, whereas the side 10 and the side 18 are in close proximity at a distance of 0.02 wavelengths in the example illustrated in FIG. 1, it is possible to achieve the advantageous effects of the summation of the currents of the side 10 and the side 18 and to achieve desired advantageous effects if the distance between the side 10 and the side 18 is equal to or shorter than 0.1 wavelengths ( 1/10 wavelengths). Note that the distance between the side 10 and the side 18 is longer than 0 wavelengths so as to avoid a short circuit.

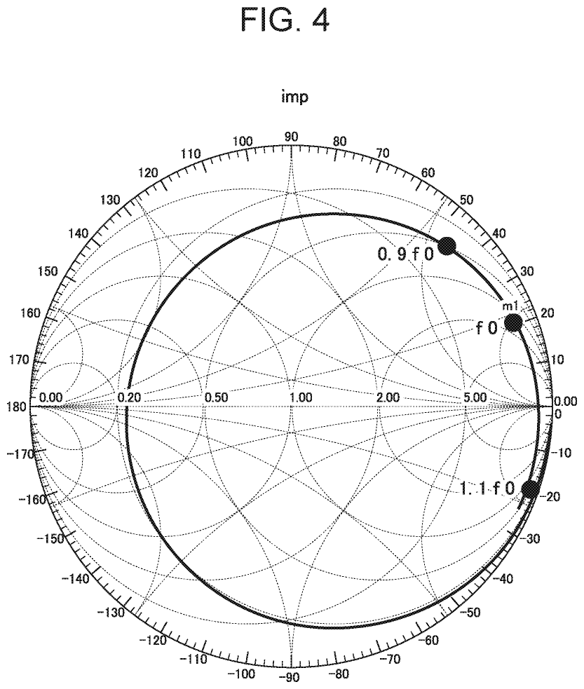

FIG. 4 is a drawing illustrating the active impedance of the antenna device 1 according to the first embodiment calculated by electromagnetic field simulation. Here, since the antenna element 3 and the antenna element 4 have symmetrical structures, and the feed point 5 and the feed point 6 are excited with equal amplitude and in phase, the active impedances of the antenna element 3 and the antenna element 4 become equal. In view of this, only the active impedance of the antenna element 3 in a case where the feed point 5 is treated as the reference plane is illustrated in FIG. 4. Note that, since the feed point 5 and the feed point 6 are excited with equal amplitude and in phase, the active impedances can be computed as the sum of reflection and coupling. According to the antenna device 1 of the first embodiment, the current that flows through the ground conductor plate 2 is reduced by adjusting the electrical length of the antenna in such a manner that the electrical length of the antenna becomes an integer multiple of the half wavelength at the design frequency (f0) and making the active impedance a high impedance, and by causing the ground conductor plate 2 to operate like a reflecting plate, the directional gain on the horizontal plane (ZX plane) can be enhanced.

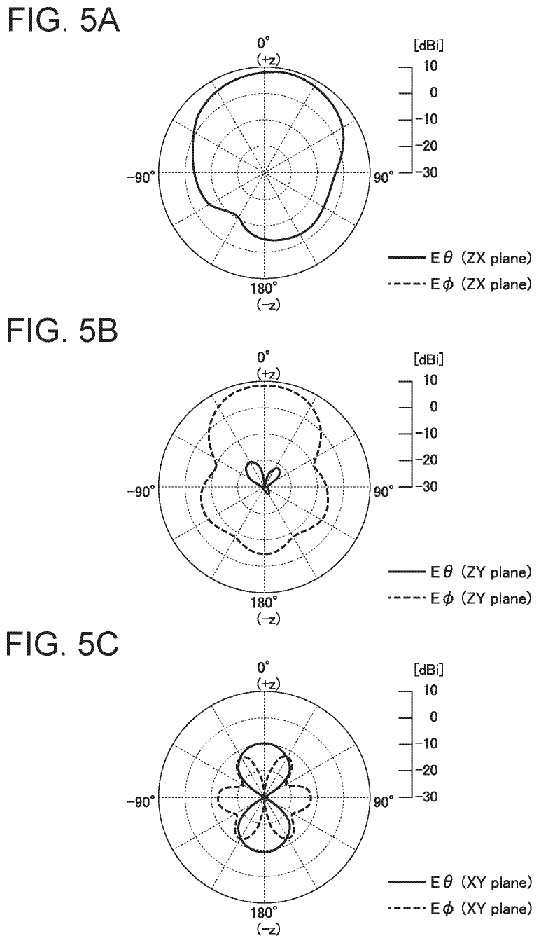

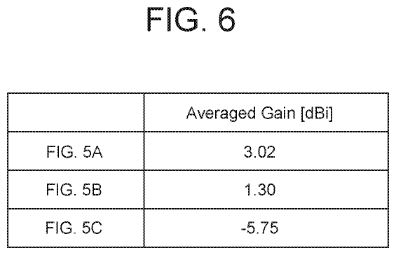

Next, advantageous effects of the antenna device 1 according to the first embodiment are explained with reference to FIGS. 5A to 5C to 7. FIGS. 5A to 5C illustrate the directional gain (dBi) of the antenna device 1 according to the first embodiment calculated by electromagnetic field simulation. FIG. 5A illustrates the directional gain on the ZX plane, FIG. 5B illustrates the directional gain on the ZY plane, and FIG. 5C illustrates the directional gain on the XY plane. Note that values of Eθ and EΦ are displayed on each drawing as the computed results. Here, when a vector from the origin to an observation point is defined as an observation vector, θ represents the separation angle of the observation vector from the Z axis, and Φ represents the separation angle, from the X axis, of a vector obtained by projecting the observation vector onto the XY plane. θ and Φ hereinbelow are also used with similar definitions. In addition, the table in FIG. 6 illustrates the averaged values of the directional gain illustrated in FIGS. 5A to 5C. The averaged values are the average values computed from all angles of the power-summed components of the true values of Eθ and EΦ. It can be seen from the results illustrated in FIGS. 5A to 5C and 6 that the directional gain on the ZX plane is the highest.

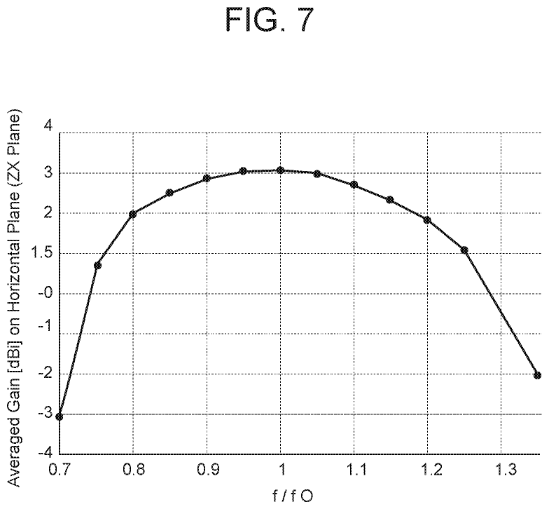

FIG. 7 illustrates the frequency characteristics of the averaged gain on the horizontal plane (ZX plane) of the antenna device 1 according to the first embodiment, and it can be seen that the averaged gain on the horizontal plane is the highest at the design frequency (f0).

Note that, whereas it is explained that the antenna element 3 and the antenna element 4 have a rectangular bent structure formed by bending the linear conductor 3b and the linear conductor 4b at right angles six times along the same direction on a plane parallel to the ground conductor plate 2, the number of bends may not be six.

In addition, whereas, in FIG. 1, the electrical lengths of the linear conductor 3b of the antenna element 3 and the linear conductor 4b of the antenna element 4 in the direction (Z direction) perpendicular to the ground conductor plate 2 are 0.07 wavelengths, it is sufficient if the electrical lengths in the Z-direction are equal to or shorter than 0.25 wavelengths. Note that if the electrical lengths in the Z-direction are made longer than 0.25 wavelengths, the directivity on the plane parallel to the ground conductor plate 2 increases undesirably, thereby decreasing the directional gain on the horizontal plane (ZX plane) undesirably.

In addition, the bending angles of the antenna element 3 and the antenna element 4 may be acute angles or obtuse angles, and the antenna element 3 and the antenna element 4 may be bent in curved shapes. In addition, the dimensions of the ground conductor plate 2 may be different from those illustrated in FIG. 1. The shape of the ground conductor plate 2 may also not be rectangle, but may be any shape.

### Second Embodiment

### Configuration

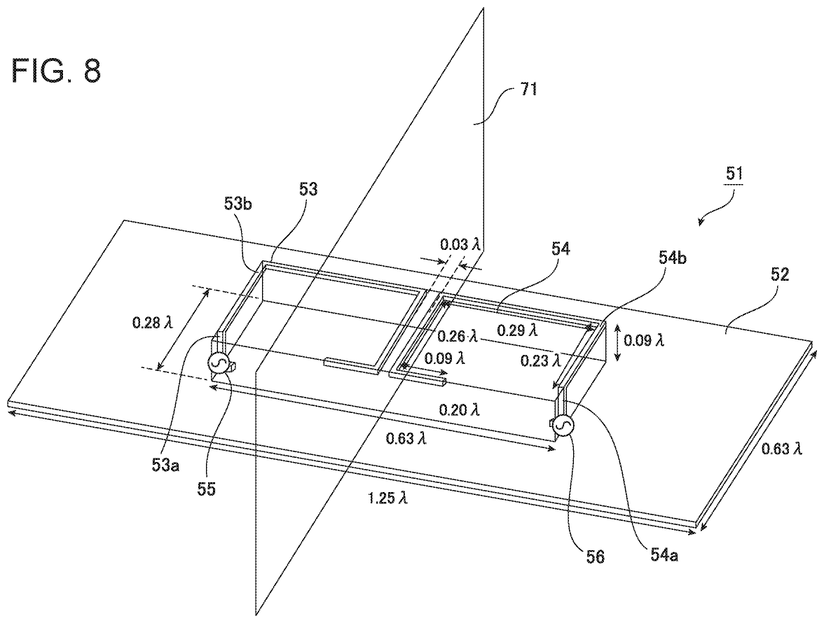

Next, an antenna device 51 according to a second embodiment of the present disclosure is explained with reference to FIGS. 8 to 14. FIG. 8 is a drawing illustrating an example of the configuration of the antenna device 51 according to the second embodiment. As illustrated in FIG. 8, the antenna device 51 includes an antenna element 53 and an antenna element 54. Simply put, in both the antenna element 53 and the antenna element 54, the numbers of the spiral turns of the antenna element 53 and the antenna element 54 are equal, and are greater than ¾ and smaller than 4/4. In the example illustrated in FIG. 8, the antenna element 53 and the antenna element 54 have a C-shape-like spiral shape in which a linear conductor 53b of the antenna element 53 and a linear conductor 54b of the antenna element 54 are bent at right angles along the same direction three times on a plane parallel to a ground conductor plate 52. The following provides a more detailed explanation.

In FIG. 8, λ represents the operating wavelength and is the free-space wavelength at a design frequency f0. As illustrated in FIG. 8, the antenna device 51 according to the second embodiment includes the ground conductor plate 52, the antenna element (first antenna element) 53, the antenna element (second antenna element) 54, a feed point (first feed point) 55, and a feed point (second feed point) 56. Note that a virtual plane 71 is drawn in FIG. 8 for the convenience of explanation. The ground conductor plate 52 has a flat shape. The virtual plane 71 is a plane perpendicular to the ground conductor plate 52. Both the antenna element 53 and the antenna element 54 have a helical shape. In the example illustrated in FIG. 8, both the antenna element 53 and the antenna element 54 have an angular spiral shape, and the numbers of the spiral turns of both the antenna element 53 and the antenna element 54 are equal, and are greater than ¾ and smaller than 4/4. The antenna element 53 and the antenna element 54 are arranged to be in mirror symmetry with respect to the virtual plane 71. In addition, the feed point 55 and the feed point 56 are also arranged to be in mirror symmetry with respect to the virtual plane 71.

The antenna element 53 includes: a linear conductor 53a extending perpendicularly to the ground conductor plate 52; and the linear conductor 53b that is continuous with the linear conductor 53a and extends parallel to the ground conductor plate 52. The linear conductor 53a and the linear conductor 53b may be a single linear conductor as a whole or may be formed integrally by connecting separate linear conductors. The linear conductor 53b is bent on a plane parallel to the ground conductor plate 52 in such a manner that the linear conductor 53b has a spiral shape.

Similarly to the antenna element 53, the antenna element 54 includes: a linear conductor 54a extending perpendicularly to the ground conductor plate 52; and the linear conductor 54b that is continuous with the linear conductor 54a and extends parallel to the ground conductor plate 52. The linear conductor 54a and the linear conductor 54b may be a single linear conductor as a whole or may be formed integrally by connecting separate linear conductors. The linear conductor 54b is bent on a plane parallel to the ground conductor plate 52 in such a manner that the linear conductor 54b has a spiral shape.

A first end of the linear conductor 53a is connected to the ground conductor plate 52 via the feed point 55. In addition, a first end of the linear conductor 54a is connected to the ground conductor plate 52 via the feed point 56.

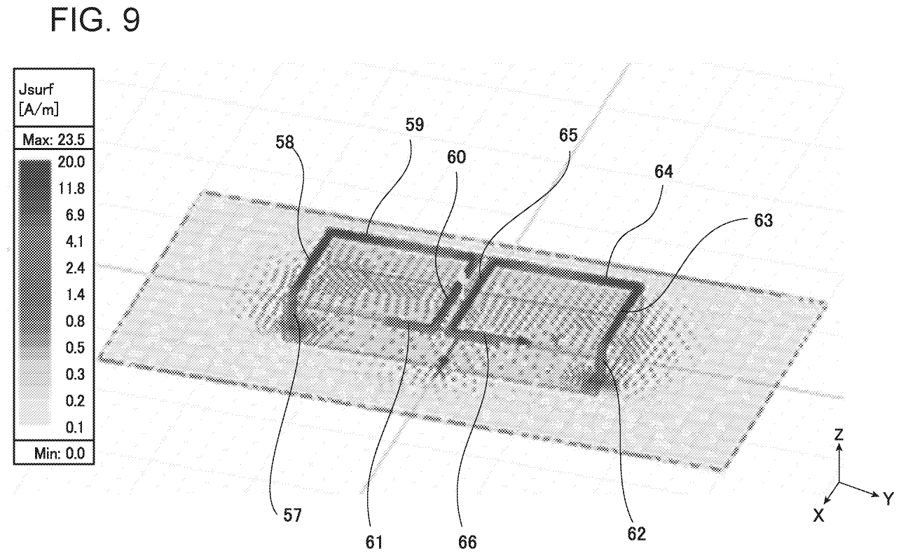

As illustrated in FIG. 9, the antenna element 53 includes the sections of a side 57 to a side 61. The side 57 is equivalent to the linear conductor 53a. The side 58 to the side 61 are equivalent to the linear conductor 53b as a whole.

In addition, as illustrated in FIG. 9, the antenna element 54 includes the sections of a side 62 to a side 66. The side 62 is equivalent to the linear conductor 54a. The side 63 to the side 66 are equivalent to the linear conductor 54b as a whole. Each of the side 57 to the side 66 has such a length that its electrical length is equal to or shorter than the half wavelength.

The side 57 of the antenna element 53 and the side 62 of the antenna element 54 have such lengths that their electrical lengths are equal to or shorter than 0.25 wavelengths. In a case where the electrical lengths of the side 57 and the side 62 are longer than 0.25 wavelengths, the directional gain on a plane parallel to the ground conductor plate 52 increases, and the directional gain on the horizontal plane (ZX plane) lowers undesirably; however, by making the electrical lengths of the side 57 and the side 62 equal to or shorter than 0.25 wavelengths, such a reduction in gain can be prevented.

As an example, the antenna element 53 and the antenna element 54 have an angular C-shaped bent structure which is formed by bending the linear conductor 53b and the linear conductor 54b at right angles three times along the same direction on a plane parallel to the ground conductor plate 52. That is, the antenna element 53 and the antenna element 54 are formed by bending the linear conductor 53b and the linear conductor 54b at right angles three times along the same direction. As a result, the antenna element 53 has an angular C-shape with the side 58 to the side 61, and the antenna element 54 has an angular C-shape with the side 63 to the side 66.

Regarding the antenna element 53, the side 58 is a side extending parallel to the X axis. The side 59 is a side extending parallel to the Y axis. The side 60 is a side extending parallel to the X axis. The side 61 is a side extending parallel to the Y axis. The antenna element 53 is bent at right angles at the three points of connection, the point of connection between the side 58 and the side 59, the point of connection between the side 59 and the side 60, and the point of connection between the side 60 and the side 61. The antenna element 53 has a plurality of bend sections (points of connection) at which the antenna element 53 is bent in this manner. The electrical length of each side (section) of the side 58 to the side 61 is equal to or shorter than half the operating wavelength (half wavelength). In addition, the total of the electrical lengths of the side 57 to the side 61 is approximately an integer multiple of half the operating wavelength (half wavelength). Here, the term “approximately” means within the range of 10%, inclusive, from a reference value. For example, it is meant that, in a case where it is assumed that 1.0 wavelengths is the integer multiple of the half wavelength, the total is within the range of 0.9 to 1.1 wavelengths.

On the other hand, regarding the antenna element 54, the side 63 is a side extending parallel to the X axis. The side 64 is a side extending parallel to the Y axis. The side 65 is a side extending parallel to the X axis. The side 66 is a side extending parallel to the Y axis. The antenna element 54 is bent at right angles at the three points of connection, the point of connection between the side 63 and the side 64, the point of connection between the side 64 and the side 65, and the point of connection between the side 65 and the side 66. The antenna element 54 has a plurality of bend sections (points of connection) at which the antenna element 54 is bent in this manner. The electrical length of each side (section) of the side 63 to the side 66 is equal to or shorter than half the operating wavelength (half wavelength). In addition, the total of the electrical lengths of the side 62 to the side 66 is approximately an integer multiple of half the operating wavelength (half wavelength). Here, the term “approximately” means within the range of 10%, inclusive, from a reference value. For example, it is meant that, in a case where it is assumed that 1.0 wavelengths is the integer multiple of the half wavelength, the total is within the range of 0.9 to 1.1 wavelengths.

The antenna element 53 and the antenna element 54 having such structures are arranged to be in mirror symmetry with respect to the virtual plane 71. In the example illustrated in FIG. 8, the shortest distance between the antenna element 53 and the antenna element 54, that is, the distance between the side 60 of the antenna element 53 and the side 65 of the antenna element 54 is 0.03 wavelengths. The electrical length of the antenna element 53 and the electrical length of the antenna element 54, that is, the total electrical length of the side 57 to the side 61 and the total electrical length of the side 62 to the side 66, are approximately integer multiples of the half wavelength.

The feed point 55 and the feed point 56 are excited with equal amplitude and in phase. The feed point 55 is positioned at a corner of an antenna area which is a rectangular parallelepiped with minimum dimensions that accommodates the antenna element 53 and the antenna element 54. The expression “positioned at a corner” includes cases where the position is within the range of 0.03 wavelengths away from the corner. The feed point 56 is positioned in mirror symmetry with the feed point 55 with respect to the virtual plane 71 perpendicular to the ground conductor plate 52.

### Operation

Next, the operation performed by the antenna device 51 according to the second embodiment is explained with reference to FIGS. 9 to 11. FIG. 9 illustrates the current distribution calculated by electromagnetic field simulation when the feed point 55 and the feed point 56 of the antenna device 51 according to the second embodiment are excited with equal amplitude and in phase.

It can be seen from FIG. 9 that currents that flow through the side 58, the side 60, the side 63, and the side 65 are relatively large. By making the electrical length of each side equal to or shorter than the half wavelength, currents that flow through sides extending in the X-axis direction can be increased, and, on the other hand, currents that flow through sides extending in the Y-axis direction can be reduced. Thereby, a plurality of directions in which large currents flow on the antenna device 51 align with the X-axis direction, and the directional gain in the Z direction increases.

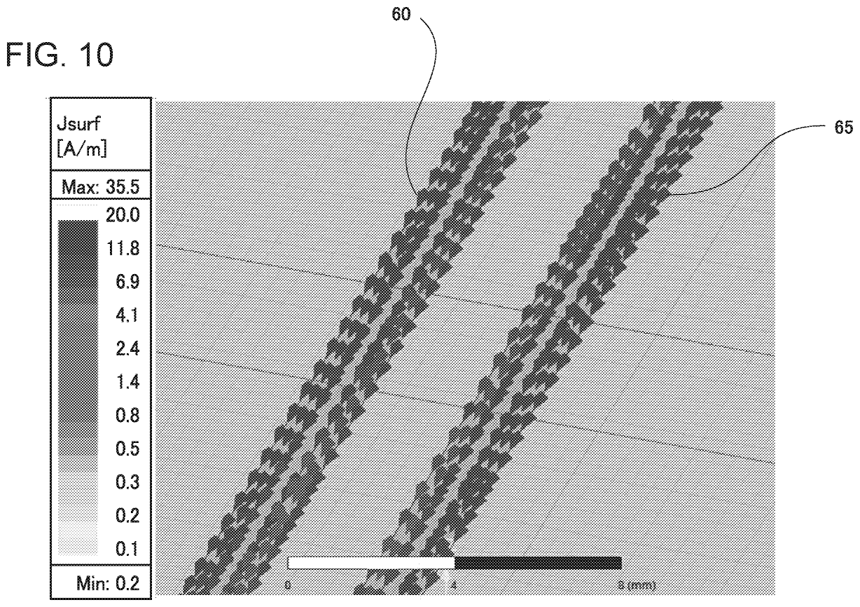

FIG. 10 is an enlarged view of the side 60 and the side 65 illustrated in FIG. 9. It can be seen that the currents flow through the side 60 and the side 65 in the same direction because the antenna element 53 and the antenna element 54 have shapes that are in mirror symmetry with respect to the virtual plane 71 perpendicular to the ground conductor plate 52, and the feed point 55 and the feed point 56 are excited with equal amplitude and in phase. Thereby, since the large currents flow through the side 60 and the side 65 and reinforce each other in phase, the overall current distribution of the side 60 and the side 65 can be regarded as equivalent to the sum of the currents that flow through the side 60 and the side 65.

As described above, the antenna device 51 according to the second embodiment exhibits a current distribution similar to that of a three-element array antenna since currents that flow through three locations, 1) the side 58, 2) the side 63, and 3) the position where the side 60 and the side 65 are viewed integrally, are in phase and large. Thereby, the directivity on the ZY plane can be narrowed, and the directional gain on the horizontal plane (ZX plane) can be enhanced.

Note that, whereas the side 60 and the side 65 are close to each other at a distance of 0.03 wavelengths in the example illustrated in FIG. 8, when the distance between the side 60 and the side 65 is equal to or shorter than 0.1 wavelengths ( 1/10 wavelengths), the effects of summing the currents of the side 60 and the side 65 is obtained, and desired effects can be obtained. Note that the distance between the side 60 and the side 65 is longer than 0 wavelengths so as to avoid a short circuit.

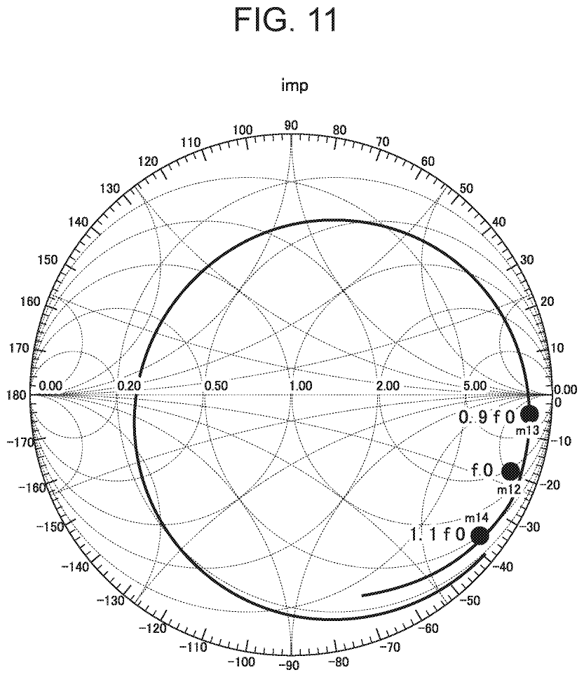

FIG. 11 is a drawing illustrating the active impedance of the antenna device 51 according to the second embodiment calculated by electromagnetic field simulation. Here, since the antenna element 53 and the antenna element 54 have symmetrical structures, and the feed point 55 and the feed point 56 are excited with equal amplitude and in phase, the active impedances of the antenna element 53 and the antenna element 54 become equal. In view of this, only the active impedance of the antenna element 53 in a case where the feed point 55 is treated as the reference plane is illustrated in FIG. 11. Note that, since the feed point 55 and the feed point 56 are excited with equal amplitude and in phase, the active impedances can be computed as the sum of reflection and coupling. According to the antenna device 51 of the second embodiment, the current that flows through the ground conductor plate 52 is reduced by adjusting the electrical length of the antenna in such a manner that the electrical length of the antenna becomes an integer multiple of the half wavelength at the design frequency (f0) and making the active impedance a high impedance, and by causing the ground conductor plate 52 to operate like a reflecting plate, the directional gain on the horizontal plane (ZX plane) can be enhanced.

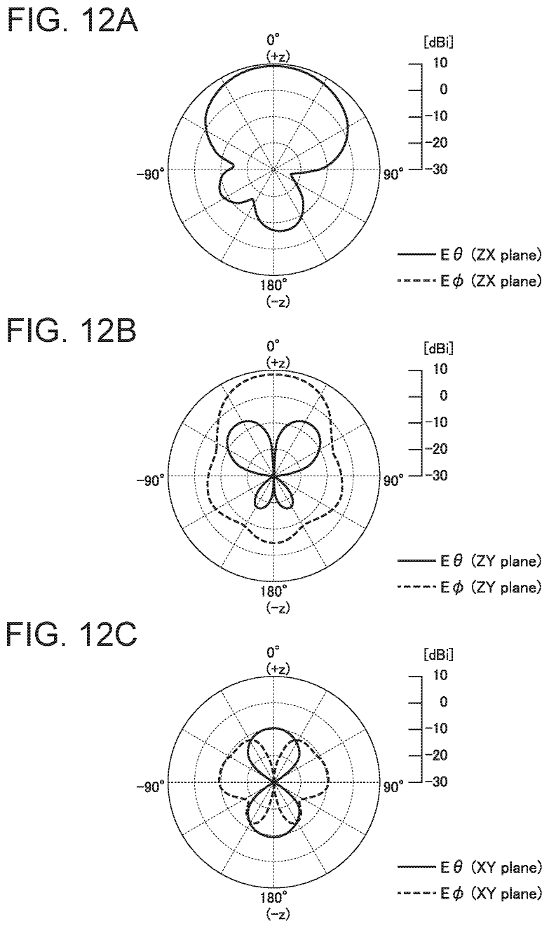

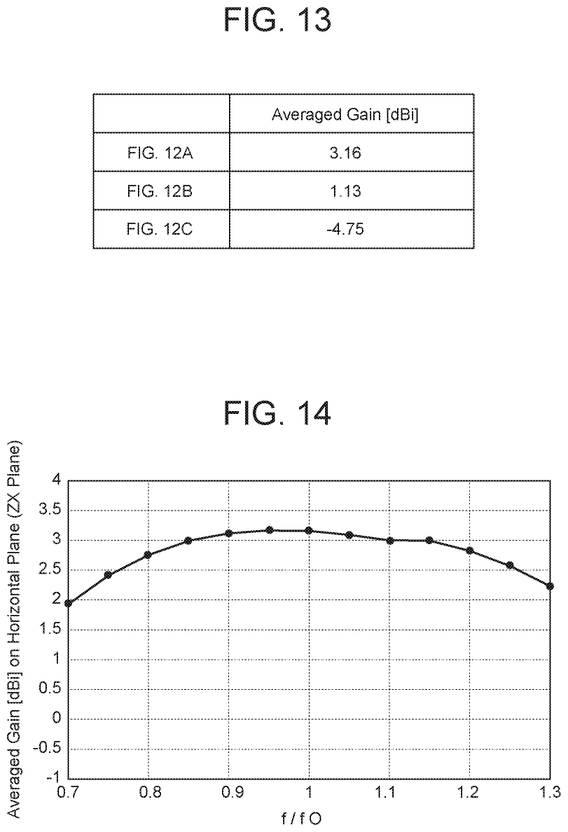

Next, advantageous effects of the antenna device 51 according to the second embodiment are explained with reference to FIGS. 12A to 12C to 14. FIGS. 12A to 12C illustrate the directional gain (dBi) of the antenna device 51 according to the second embodiment calculated by electromagnetic field simulation. FIG. 12A illustrates the directional gain on the ZX plane, FIG. 12B illustrates the directional gain on the ZY plane, and FIG. 12C illustrates the directional gain on the XY plane. Note that values of Eθ and EΦ are displayed on each drawing as the computed results. In addition, the table in FIG. 13 illustrates the averaged values of the directional gain illustrated in FIGS. 12A to 12C. The averaged values are the average values computed from all angles of the power-summed components of the true values of Eθ and EΦ. It can be seen from the results illustrated in FIGS. 12A to 12C and 13 that the directional gain on the ZX plane is the highest.

FIG. 13 illustrates the frequency characteristics of the averaged gain on the horizontal plane (ZX plane) of the antenna device 51 according to the second embodiment, and it can be seen that the averaged gain on the horizontal plane is the highest at the design frequency (f0).

Note that, whereas it is explained that the antenna element 53 and the antenna element 54 have a rectangular bent structure in which the linear conductor 53b and the linear conductor 54b are bent at right angles along the same direction three times on a plane parallel to the ground conductor plate 52, the number of bends may not be three. In addition, whereas it is assumed in FIG. 8 that the electrical lengths of the linear conductor 53b of the antenna element 53 and the linear conductor 54b of the antenna element 54 in the direction perpendicular to the ground conductor plate 52 (Z direction) are set to 0.09 wavelengths, however, it is sufficient if the electrical lengths in the Z-direction are equal to or shorter than 0.25 wavelengths. Note that if the electrical lengths in the Z-direction are made longer than 0.25 wavelengths, the directivity on the plane parallel to the ground conductor plate 52 increases undesirably, which results in a decrease in the directional gain in the horizontal plane (ZX plane).

In addition, the bending angles of the antenna element 53 and the antenna element 54 may be acute angles or obtuse angles, and the antenna element 53 and the antenna element 54 may be bent in curved shapes. In addition, the dimensions of the ground conductor plate 52 may be different from those illustrated in FIG. 8. The shape of the ground conductor plate 52 is not limited to a rectangle, and may be any shape.

Note that the embodiments can be combined, and the respective embodiments can be modified or omitted as appropriate.

### INDUSTRIAL APPLICABILITY

The antenna devices according to the present disclosure can be used as antenna devices in various fields such as wireless communication systems that are required to achieve high gain and to be miniaturized.

### REFERENCE SIGNS LIST

1: Antenna device, 2: Ground conductor plate, 3: Antenna element, 3a: Linear conductor, 3b: Linear conductor, 4: Antenna element, 4a: Linear conductor, 4b: Linear conductor, 5: Feed point, 6: Feed point, 7 to 22: Side, 51: Antenna device, 52: Ground conductor plate, 53: Antenna element, 53a: Linear conductor, 53b: Linear conductor, 54: Antenna element, 54a: Linear conductor, 54b: Linear conductor, 55: Feed point, 56: Feed point, 57 to 66: Side, 70: Virtual plane, 71: Virtual plane

1. An antenna device comprising:
a flat ground conductor plate;
a first antenna element having a first linear conductor extending perpendicularly to the ground conductor plate, and a second linear conductor with a spiral shape that is continuous with the first linear conductor and extends parallel to the ground conductor plate;
a first feed point to supply power to the first antenna element, the first feed point being grounded to the ground conductor plate;
a second antenna element having a third linear conductor extending perpendicularly to the ground conductor plate, and a fourth linear conductor with a spiral shape that is continuous with the third linear conductor and extends parallel to the ground conductor plate; and
a second feed point to supply power to the second antenna element, the second feed point being grounded to the ground conductor plate, wherein the first antenna element and the second antenna element are arranged in mirror symmetry with respect to a virtual plane perpendicular to the ground conductor plate,
the first feed point and the second feed point are arranged in mirror symmetry with respect to the virtual plane, and
an electrical length of a shortest distance between the first antenna element and the second antenna element is equal to or shorter than 1/10 of an operating wavelength, wherein
the second linear conductor and the fourth linear conductor each have a plurality of bend sections bent at right angles along a same direction multiple times on a plane parallel to the ground conductor plate, and wherein
electrical lengths of all sections between adjacent bend sections of the second linear conductor are equal to or shorter than half the operating wavelength, and
electrical lengths of all sections between adjacent bend sections of the fourth linear conductor are equal to or shorter than half the operating wavelength.

2. An antenna device comprising:
a flat ground conductor plate;
a first antenna element having a first linear conductor extending perpendicularly to the ground conductor plate, and a second linear conductor with a spiral shape that is continuous with the first linear conductor and extends parallel to the ground conductor plate;
a first feed point to supply power to the first antenna element, the first feed point being grounded to the ground conductor plate;
a second antenna element having a third linear conductor extending perpendicularly to the ground conductor plate, and a fourth linear conductor with a spiral shape that is continuous with the third linear conductor and extends parallel to the ground conductor plate; and
a second feed point to supply power to the second antenna element, the second feed point being grounded to the ground conductor plate, wherein
the first antenna element and the second antenna element are arranged in mirror symmetry with respect to a virtual plane perpendicular to the ground conductor plate,
the first feed point and the second feed point are arranged in mirror symmetry with respect to the virtual plane, and
an electrical length of a shortest distance between the first antenna element and the second antenna element is equal to or shorter than 1/10 of an operating wavelength, and wherein
a total of electrical lengths of the first linear conductor and the second linear conductor is an integer multiple of half the operating wavelength, and
a total of electrical lengths of the third linear conductor and the fourth linear conductor is an integer multiple of half the operating wavelength.

3. The antenna device according to claim 2, wherein the second linear conductor and the fourth linear conductor each have a plurality of bend sections bent at right angles along a same direction multiple times on a plane parallel to the ground conductor plate.

4. The antenna device according to claim 3, wherein
electrical lengths of all sections between adjacent bend sections of the second linear conductor are equal to or shorter than half the operating wavelength, and
electrical lengths of all sections between adjacent bend sections of the fourth linear conductor are equal to or shorter than half the operating wavelength.

5. The antenna device according to claim 1, wherein
a total of electrical lengths of the first linear conductor and the second linear conductor is an integer multiple of half the operating wavelength, and
a total of electrical lengths of the third linear conductor and the fourth linear conductor is an integer multiple of half the operating wavelength.

6. The antenna device according to claim 1, wherein the first feed point and the second feed point are excited with equal amplitude and in phase.

7. The antenna device according to claim 2, wherein the first feed point and the second feed point are excited with equal amplitude and in phase.

8. The antenna device according to claim 1, wherein
the first feed point is positioned at a corner of an antenna area which is a rectangular parallelepiped with minimum dimensions that accommodates the first antenna element and the second antenna element, and
the second feed point is positioned at another corner of the antenna area.

9. The antenna device according to claim 2, wherein
the first feed point is positioned at a corner of an antenna area which is a rectangular parallelepiped with minimum dimensions that accommodates the first antenna element and the second antenna element, and
the second feed point is positioned at another corner of the antenna area.
